(19) United States
(12) Patent Application Publication
(10) Pub. No.: US 2026/0238911 A1
(43) Pub. Date: Aug. 13, 2026

(54) TRANSLATION SYSTEM BASED ON POWER BANK AND EARPHONE CHARGING CASE

(71) Applicant: Beijing Newman Tengfei Technology Co., LTD, Beijing (CN)

(72) Inventor: Hongfeng Wang, Beijing (CN)

(73) Assignee: Beijing Newman Tengfei Technology Co., LTD, Beijing (CN)

(21) Appl. No.: 19/434,541

(22) Filed: Dec. 29, 2025

(30) Foreign Application Priority Data
Feb. 12, 2025 (CN) 202520222534.2

(51) Int. Cl. H04R 1/1025; G08B 3/10; G08B 21/18; H04R 1/02; H04R 1/10; G06F 40/00

(52) U.S. Cl. CPC H04R 1/1025; G08B 3/10; G08B 21/182; H04R 1/028; H04R 1/1041; G06F 40/00; H04R 2420/07; H04R 2499/11; H04R 2499/15

(57) ABSTRACT

A translation system based on a power bank and an earphone charging case is provided. By means of the arrangement of a Bluetooth low energy (BLE) module, a Push-to-Talk (PTT) button, a sound pickup module, a control module, a speaker module, and a power supply module, when translation is required, the PTT button may be pressed, the control module controls the sound pickup module to capture voice information of a user, and after being subjected to data compression, the voice information is sent to a cellphone APP via the BLE module. After the cellphone APP receives the voice information, the voice information is synchronously sent to a cloud server for translation.

### TECHNICAL FIELD

The present disclosure relates to the technical field of power banks and earphone charging cases, and in particular to a translation system based on a power bank and an earphone charging case.

### BACKGROUND

A power bank, also known as a portable power supply, a portable charger, an external battery pack, a power buddy, or a travel charger, is a portable charger that may be carried around by a user, has the ability to store electrical energy, and is mainly used for charging consumer electronic products such as handheld mobile devices (e.g., wireless phones and laptops). The power bank is particularly applied in situations where there is no external power supply available. The main components of the power bank include a battery for storing electrical energy, and a circuit for stabilizing an output voltage (a direct current-direct current converter). Most power banks are equipped with chargers, which are used for charging built-in batteries.

An earphone charging case is also a device with an energy storage function, which is mainly used for charging matching Bluetooth earphones, and may also be used for emergency charging of external cellphones.

However, the functions of the power banks and the earphone charging cases in the prior art are relatively single. Apart from charging electrical devices, the power banks and the earphone charging cases have no other functions and fail to meet the diverse needs of users.

### SUMMARY

An objective of the present disclosure is to provide a translation system based on a power bank and an earphone charging case, so as to solve the single function problem of power banks proposed in the background.

To achieve the above objective, the present disclosure provides the technical solutions as follows:

A translation system based on a power bank and an earphone charging case includes a Bluetooth low energy (BLE) module, a Push-to-Talk (PTT) button, a sound pickup module, a control module, a speaker module, and a power supply module; where

the BLE module is configured to perform interactive transmission of data with the control module and an external cellphone terminal, respectively, signal output ends of the PTT button and the sound pickup module are connected to signal input ends of the control module, respectively, a signal output end of the control module is connected to a signal input end of the speaker module, and the power supply module supplies power to the BLE module, the sound pickup module, and the speaker module, respectively through the control module.

In an embodiment, the translation system based on a power bank and an earphone charging case further includes an input charging female socket, and the input charging female socket is electrically connected to the power supply module through the control module, and is configured to be connected to an external charging power supply to charge the power supply module.

In an embodiment, the translation system based on a power bank and an earphone charging case further includes an output charging female socket, and the output charging female socket is electrically connected to the power supply module through the control module, and is configured to charge an external electrical appliance through the power supply module.

In an embodiment, the translation system based on a power bank and an earphone charging case further includes a storage module, and the storage module is connected to the control module, and is configured to store translation information.

In an embodiment, the translation system based on a power bank and an earphone charging case further includes a display module, and an output end of the control module is connected to an input end of the display module, so as to display translation information.

In an embodiment, the power supply module includes a battery level measurement unit, and the battery level measurement unit is electrically connected to the control module, and is configured to measure a battery level value of the power supply module in real time and send the battery level value to the control module.

In an embodiment, the translation system based on a power bank and an earphone charging case further includes an alarm module, and an output end of the control module is connected to an input end of the alarm module, so as to give an alarm when a battery level of the power supply module is lower than a preset threshold.

In an embodiment, the alarm module is either a speaker or a buzzer.

In an embodiment, the translation system based on a power bank and an earphone charging case further includes a Save Our Souls (SOS) alarm button, and the SOS alarm button is electrically connected to the control module.

Compared with the prior art, the present disclosure has the beneficial effects as follows:

In the translation system based on a power bank and an earphone charging case, by means of the cooperative arrangement of the BLE module, the PTT button, the sound pickup module, the control module, the speaker module, and the power supply module, when translation is required, the PTT button may be pressed, the control module controls the sound pickup module to capture voice information of a user, and the voice information is sent to a cellphone APP via the BLE module. After the cellphone APP receives the voice information, the voice information is synchronously sent to a cloud server for translation. Translation results are received by the cellphone APP, and then are sent to the BLE module after being subjected to data compression. After being compressed through the BLE module, the translation information is sent to the control module of the translation system based on a power bank and an earphone charging case. After being decoded by the control module, the translation information is played through the speaker module. Therefore, the use is very convenient, and there is no need to open cellphone translation software, thereby achieving a more convenient and faster effect, enriching the functions of the power bank and the earphone charging case, and meeting the diverse needs of the user.

### BRIEF DESCRIPTION OF THE DRAWINGS

FIG. 1 is a schematic structural view of a translation system based on a power bank and an earphone charging case in the present disclosure.

FIG. 2 is a schematic structural view of a power supply module of a translation system based on a power bank and an earphone charging case in the present disclosure.

### DETAILED DESCRIPTIONS OF THE EMBODIMENTS

To enable the objectives, features, and advantages mentioned above of the present disclosure to be more apparent and easily understood, particular implementations of the present disclosure will be described in detail below in combination with the accompanying drawings. Many specific details are set forth in the following description to facilitate full understanding of the present disclosure. However, the present disclosure may be implemented in many other ways different from those described herein, similar improvements may be made by those skilled in the art without departing from the connotation of the present disclosure, and therefore the present disclosure is not limited by the particular embodiments disclosed below.

It should be noted that when an element is considered to be “connected” to another element, the element may be directly connected to another element or there may be an intermediate element simultaneously. On the contrary, when the element is referred to as being “directly” connected to another element, there is no intermediate element.

Unless otherwise defined, all technical and scientific terms used herein have the same meaning as commonly understood by those skilled in the technical field of the present disclosure. The terms used in the description of the present disclosure herein are just for the purpose of describing specific implementations, and are not intended to limit the present disclosure. The term “and/or” used herein includes any and all combinations of one or more related items listed.

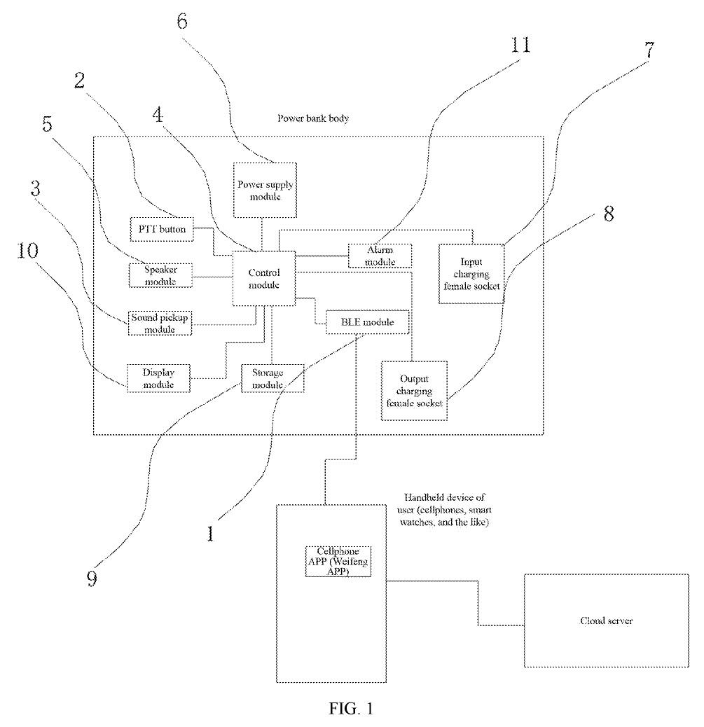

With reference to FIG. 1, a translation system based on a power bank and an earphone charging case, including a Bluetooth low energy (BLE) module 1, a Push-to-Talk (PTT) button 2, a sound pickup module 3, a control module 4, a speaker module 5, and a power supply module 6.

The BLE module 1 is configured to perform interactive transmission of data with the control module 4 and an external cellphone terminal, respectively, signal output ends of the PTT button 2 and the sound pickup module 3 are connected to signal input ends of the control module 4, respectively, a signal output end of the control module 4 is connected to a signal input end of the speaker module 5, and the power supply module 6 supplies power to the BLE module 1, the sound pickup module 3, and the speaker module 5, respectively through the control module 4.

The BLE module may be configured to compress data, and may perform quick transmission of the data. Generally, the sound pickup module 3 may be a microphone, the speaker module 5 may be connected to an external loudspeaker, and the power supply module 6 is usually a battery. Furthermore, when a cellphone is only connected to the BLE module 1, original traditional Bluetooth functions are not affected, such as not interfering with the original call and music playback functions. Moreover, power consumption may be effectively reduced when a continuous connection is maintained, thereby achieving greater practical significance.

When a translation function is required, the PTT button 2 is pressed, and the control module 4 controls the BLE module 1 to establish a Bluetooth connection to the cellphone. The control module 4 controls the sound pickup module 3 to capture voice information of a user, and the voice information is sent to a cellphone APP through the BLE module 1. After the cellphone APP receives the voice information, the voice information is synchronously sent to a cloud server for translation. Translation results are received by the cellphone APP from the cloud server, and sent to the BLE module 1 after being subjected to data compression. After being compressed through the BLE module 1, the translation information is sent to the control module 4 of a power bank body and an earphone charging case body. After being decoded by the control module 4, the translation information is played through the speaker module 5, thereby completing translation of the voice information. The default translation in the present disclosure is from Chinese to English.

In this way, according to the translation system based on a power bank and an earphone charging case, by means of the cooperative arrangement of the BLE module 1, the PTT button 2, the sound pickup module 3, the control module 4, the speaker module 5, and the power supply module 6, when translation is required, the PTT button 2 may be pressed, the control module 4 controls the sound pickup module 3 to capture the voice information of the user, and the voice information is sent to the cellphone APP via the BLE module 1. After the cellphone APP receives the voice information, the voice information is synchronously sent to the cloud server for translation. Translation results are received by the cellphone APP, and then are sent to the BLE module 1 after being subjected to data compression. After being compressed through the BLE module 1, the translation information is sent to the control module 4 of the power bank body and the earphone charging case body. After being decoded by the control module 4, the translation information is played through the speaker module 5. Therefore, the use is very convenient, and there is no need to open cellphone translation software, thereby achieving a more convenient and faster effect, enriching the functions of the power bank and the earphone charging case, and meeting the diverse needs of the user.

In an embodiment, the translation system based on a power bank and an earphone charging case further includes an input charging female socket 7, and the input charging female socket 7 is electrically connected to the power supply module 6 through the control module 4, and is configured to be connected to an external charging power supply to charge the power supply module 6.

In an embodiment, the translation system based on a power bank and an earphone charging case further includes an output charging female socket 8, and the output charging female socket 8 is electrically connected to the power supply module 6 through the control module 4, and is configured to charge an external electrical appliance through the power supply module 6.

Thus, the power supply module 6 of the translation system based on a power bank and an earphone charging case is charged through the input charging female socket 7, and the external electrical appliance is charged through the output charging female socket 8.

In an embodiment, the translation system based on a power bank and an earphone charging case further includes a storage module 9, and the storage module 9 is connected to the control module 4, and is configured to store translation information.

Thus, both the voice information of the user captured by the sound pickup module 3 and the corresponding translation information may both be stored in a preset location of the storage module 9 for subsequent reference when needed.

In an embodiment, the translation system based on a power bank and an earphone charging case further includes a display module 10, and an output end of the control module 4 is connected to an input end of the display module 10, so as to display translation information.

In this way, when the translation information is sent to the control module 4 via the BLE module 1, the control module 4 may display the translated content through the display module 10, such that the user may also obtain visual information synchronously while listening to the translated audio, thereby acquiring the translated content quickly and accurately, and avoiding the inability to quickly and accurately obtain the translated content caused by only relying on the audio to access the translated content.

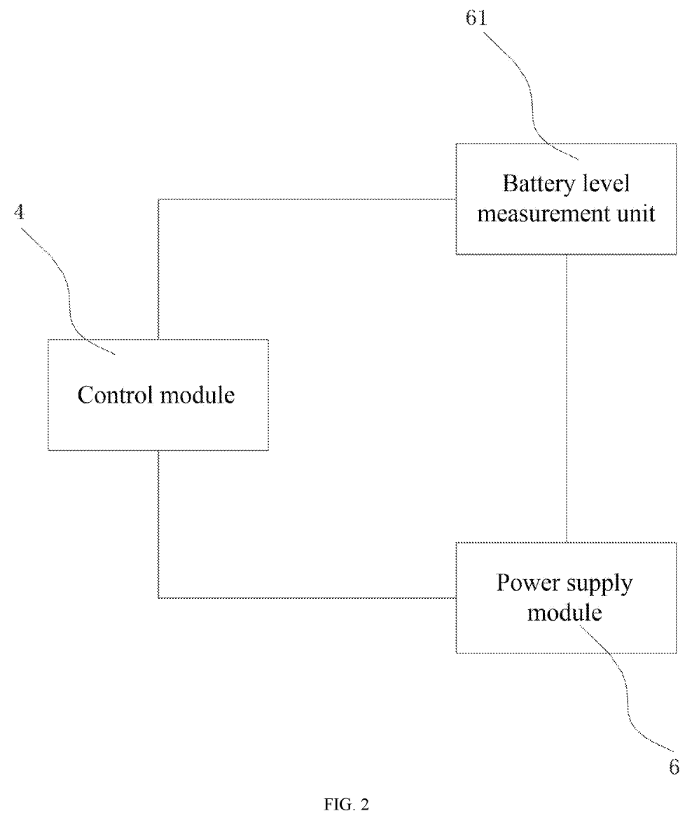

With reference to FIG. 2, in an embodiment, the power supply module 6 includes a battery level measurement unit 61, and the battery level measurement unit 61 is electrically connected to the control module 4, and is configured to measure a battery level value of the power supply module 6 in real time and send the battery level value to the control module 4.

The translation system based on a power bank and an earphone charging case further includes an alarm module 11, an output end of the control module 4 is connected to an input end of the alarm module 11, so as to give an alarm when a battery level of the power supply module 6 is lower than a preset threshold. The alarm module 11 is either a speaker or a buzzer.

In this way, the battery level measurement unit 61 measures the battery level value of the power supply module 6 in real time and sends the battery level value to the control module 4. When the battery level of the power supply module 6 is lower than the preset threshold, the alarm module 11 gives an alarm to remind the user that the battery level of the power supply module 6 is low and charging is needed in a timely manner.

In an embodiment, the translation system based on a power bank and an earphone charging case further includes a Save Our Souls (SOS) alarm button, and the SOS alarm button is electrically connected to the control module 4.

In this way, in case of danger, an alarm signal may be triggered by pressing the SOS alarm button. The control module 4 controls the BLE module 1 to transmit the alarm signal to the cellphone APP, and the cellphone further sends the alarm signal to cellphones of bound guardians or relatives.

Furthermore, when the translation system based on a power bank and an earphone charging case is far away from the cellphone and the Bluetooth connection is disconnected, the cellphone APP will prompt that the translation system based on a power bank and an earphone charging case has been disconnected from the cellphone body, reminding the user to check whether the power bank has been lost.

What are described above are merely preferred particular implementations of the present disclosure, but the protection scope of the present disclosure is not limited thereto. Equivalent substitutions or changes that are made by any of those skilled in the art and familiar with the technical field within the technical scope disclosed by the present disclosure on the basis of the technical solutions and concepts of the present disclosure should be covered within the protection scope of the present disclosure.

What is claimed is:

1. A translation system based on a power bank and an earphone charging case, comprising a Bluetooth low energy (BLE) module, a Push-to-Talk (PTT) button, a sound pickup module, a control module, a speaker module, and a power supply module, wherein
the BLE module is configured to perform interactive transmission of data with the control module and an external cellphone terminal, respectively, signal output ends of the PTT button and the sound pickup module are connected to signal input ends of the control module, respectively, a signal output end of the control module is connected to a signal input end of the speaker module, and the power supply module supplies power to the BLE module, the sound pickup module, and the speaker module, respectively through the control module.

2. The translation system based on a power bank and an earphone charging case according to claim 1, further comprising an input charging female socket, wherein the input charging female socket is electrically connected to the power supply module through the control module, and is configured to be connected to an external charging power supply to charge the power supply module.

3. The translation system based on a power bank and an earphone charging case according to claim 1, further comprising an output charging female socket, wherein the output charging female socket is electrically connected to the power supply module through the control module, and is configured to charge an external electrical appliance through the power supply module.

4. The translation system based on a power bank and an earphone charging case according to claim 2, further comprising a storage module, wherein the storage module is connected to the control module, and is configured to store translation information.

5. The translation system based on a power bank and an earphone charging case according to claim 1, further comprising a display module, wherein an output end of the control module is connected to an input end of the display module, so as to display translation information.

6. The translation system based on a power bank and an earphone charging case according to claim 1, wherein the power supply module comprises a battery level measurement unit, and the battery level measurement unit is electrically connected to the control module, and is configured to measure a battery level value of the power supply module in real time and send the battery level value to the control module.

7. The translation system based on a power bank and an earphone charging case according to claim 6, further comprising an alarm module, wherein an output end of the control module is connected to an input end of the alarm module, so as to give an alarm when a battery level of the power supply module is lower than a preset threshold.

8. The translation system based on a power bank and an earphone charging case according to claim 7, wherein the alarm module is either a speaker or a buzzer.

9. The translation system based on a power bank and an earphone charging case according to claim 1, further comprising a Save Our Souls (SOS) alarm button, wherein the SOS alarm button is electrically connected to the control module.
